(19) United States
(12) Patent Application Publication
(10) Pub. No.: US 2016/0238423 A1
(43) Pub. Date: Aug. 18, 2016

(54) Flow Metering

(71) Applicants: Western Energy Support & Technology, Inc., Nunn, CO (US); DP Diagnostics LLC, Windsor, CO (US)

(72) Inventors: Richard Steven, Johnstown, CO (US); Terrence Cousins, Loveland, CO (US); Jerry Caldwell, Cheyenne, WY (US)

(21) Appl. No.: 15/027,039

(22) PCT Filed: Sep. 24, 2014
(86) PCT No.: PCT/GB2014/052898

§ 371 Date: Apr. 4, 2016

(30) Foreign Application Priority Data
Oct. 3, 2013 (GB) 1317486.7

(51) Int. Cl. G01F 1/74; G01F 1/36

(52) U.S. Cl. CPC G01F 1/74; G01F 1/366

(57) ABSTRACT

Methods and apparatus for the metering of two-component, single-phase fluid flow. A primary element of a differential pressure flow meter is used as a joint mixer and flow meter. Diagnostic techniques can be applied to detect and help determine the cause of erroneous meter readings. A volume meter can also be provided downstream of the differential pressure meter, and the respective outputs can be cross-referenced to produce a mass flow rate, volume flow rate and density output with no prior knowledge of fluid density required.

### CROSS-REFERENCE TO RELATED APPLICATIONS

The present application is a National Stage Application of PCT International Application No. PCT/GB2014/052898 (filed on Sep. 24, 2014), under 35 U.S.C. §371, which claims priority to Great Britain Patent Application No. 1317486.7 (filed on Oct. 3, 2013), which are each hereby incorporated by reference in their respective entireties.

### TECHNICAL FIELD

The present disclosure relates to flow metering, and in particular to new methods and apparatus for the metering of two component single-phase fluid flow, such as water and oil.

### BACKGROUND

Water in oil production flows is a significant problem to the hydrocarbon production industry.

For decades many large oil fields produced relatively little water. With the price of oil traditionally low in real terms compared to today the relatively small flow measurement biases induced by the water was largely seen as a minor annoyance. As such this issue was dealt with by approximate means, appropriate for a low water to oil ratios (or ‘water-cuts’) and relatively low oil prices.

Today the situation is changing. With higher oil prices, even small oil flow metering biases can be financially significant. Many larger oil fields are aging and now producing significantly higher water cuts than before. Due to the price of oil they are still viable, and will be for years to come, even as the water cut continues to increase. Furthermore, oil fields that would produce high water-cuts from the outset, previously considered unviable, are becoming viable as the value of oil increases. Therefore, the combined effects of significantly higher oil prices and more high ‘water-cut’ oil production flows have made metering water and oil mixture flows a significant problem.

The long accepted methodology of metering the flow of oil with water mixtures is to combine the two separate procedures of total volume flow metering and sampling.

Traditionally a single-phase volume meter, designed for operation with a homogenous single component flow (for example, just for oil flow or just for water flow) would be utilised to provide a total volume flow estimation. Volume meters are a group of meters that do not require the fluid density to be known as a calculation input in order to predict the flow's average velocity and volume flow rate. This group of flow meters (sometimes referred to as velocity, linear or volume meters) include the ultrasonic meter, the positive displacement meter, vortex meter and the turbine meter. These meters produce a volume flow rate prediction. The mass flow rate prediction is then obtained by taking the product of the volume meters volume flow rate prediction and a separate independent fluid density measurement obtained from an external source.

The volume flow rate is sometimes converted to volume at standard conditions. For liquids there is little difference between standard and actual flow conditions (unless there is de-gassing issues) and any difference between actual and standard conditions is simply a thermodynamic conversion which has no bearing on this discussion. Flow meters initially measure that which is there, i.e. actual volume conditions.

A mixing device is installed in the pipe work to induce a homogenous mix of oil and water directly downstream of the mixer. A sample is taken downstream of this mixer on the assumption that the mixer is 100% efficient, i.e. it mixes the oil and water such that the resulting flow is a pseudo-single-phase flow with one average velocity and one set of averaged properties. It is assumed that when this sample settles the static volume ratio of water to oil is the same as the ratio of the water to oil flow rates.

The oil flow rate of a water and oil mixture is the primary measurement of interest for hydrocarbon production predictions; and the water flow rate is also of financial interest as there are associated costs to separation and water treatment. In order to predict these two flow rates, it is necessary to combine the flow meter's total volume flow rate prediction and the sampling systems ‘water-cut’ prediction. The existing methodology involves taking a sample downstream of a mixer to give a water to oil ratio from which the average (or ‘homogenized’) density can be predicted, and using this homogenized (i.e. averaged) density in conjunction with a flow meter's total volume flow prediction to predict the oil and water flows.

The uncertainty of the oil and water volume flow rates (Qₒᵢₗ & Q_{water} respectively), or mass flow rates (mₒᵢₗ & m_{water} respectively) are dependent on both the flow rate prediction and the sample ‘water-cut’ uncertainty. Any significant bias in either the volume or mass flow rate prediction (Qₜₒₜₐₗ or mₜₒₜₐₗ) and/or the sampling water-cut (ω) prediction will produce significant biases in the oil and water flow rate predictions.

$$\begin{matrix}{Q}_{total} = {Q}_{oil} + {Q}_{water} & ( 1 ) \\ ω = \frac{{Q}_{water}}{{Q}_{water} + {Q}_{oil}} = \frac{{Q}_{water}}{{Q}_{total }} & ( 2 ) \\ 1 - ω = \frac{{Q}_{oil}}{{Q}_{water} + {Q}_{oil}} = \frac{{Q}_{oil}}{{Q}_{total}} & ( 2 a ) \\ {Q}_{water} = {Q}_{total} * \frac{{Q}_{water}}{{Q}_{total}} = {Q}_{total} * ω & ( 3 ) \\ {Q}_{oil} = {Q}_{total} * ( 1 - \frac{{Q}_{water}}{{Q}_{total}} ) = {Q}_{total} * ( 1 - ω ) & ( 4 )\end{matrix}$$

However, with these existing techniques, the unproven assumption of perfect mixing and errors in the flow rate prediction do in fact produce errors which are significant. It is desirable to improve metering accuracy for mixed oil and water flow.

### SUMMARY

According to a first aspect of the disclosure there is provided a method of metering a fluid flow comprising at least two components comprising: measuring a differential pressure caused by a primary element sampling the fluid flow after the components of the fluid flow are mixed by the primary element; finding a ratio of a first component of the fluid to a second component of the fluid from said sampled fluid; for initially known individual component densities, calculating an average density from the ratio of a first component of the fluid to a second component of the fluid; calculating a total fluid flow rate based on the differential pressure measurement; and combining the total fluid flow rate and component ratios to determine a first fluid flow rate for the first component and a second fluid flow rate for the second component.

A “total” fluid flow rate is the flow rate of the entire fluid flow, that is, including all components of the flow.

Optionally, the fluid flow is a single-phase flow. Alternatively, the fluid flow may be a multiphase flow.

One example type of single-phase, two component flow is that of oil and water. It is to be appreciated that such a flow may comprise small amounts of entrained gas or particulate matter such as sand, and may still be considered as being of a “single-phase and two component” type if these entrained materials are present only in trace amounts or at a level that has no practical bearing on the techniques of the disclosure. Fluid flows which comprise substantial amounts of gas and/or solids along with water and oil are considered to be “multiphase.”

Optionally, the primary element comprises a cone shaped structure within a fluid conduit.

Optionally, the primary element comprises a wedge shaped structure within a fluid conduit.

Optionally, the primary element comprises an orifice plate structure within a fluid conduit.

Optionally, the primary element comprises a Venturi-shaped constriction formed in a fluid conduit.

Optionally, the fluid flow comprises an oil component and a water component.

Optionally, the fluid flow comprises an oil component and a water component with entrained gas.

Optionally, measuring a differential pressure comprises comparing the pressures between any two of: a conduit position upstream of the primary element; a conduit position downstream of the primary element; and an intermediate conduit position between the upstream and downstream positions.

Optionally, the method comprises measuring at least two differential pressures selected from: a permanent pressure loss (PPL) differential pressure taken between the upstream and downstream conduit positions; a traditional differential pressure taken between the upstream and intermediate conduit positions; a recovered differential pressure taken between the intermediate and downstream conduit positions.

Optionally, the method comprises calculating a fluid flow rate using one of the differential pressure measurements; and monitoring the accuracy of this fluid flow rate by examining the relationship between the measured differential pressures.

Optionally, the method comprises calculating a fluid flow rate using each of the differential pressure measurements; and determining that the fluid components are well mixed if the calculated flow rate predictions match each other.

A match is deemed to occur when the predicted flow rates are within a predetermined uncertainty threshold of each other.

Optionally, the traditional differential pressure is used with a corresponding traditional flow rate prediction in conjunction with the component ratio of fluid components obtained from the sampled fluid, known individual component densities and a corresponding homogenous density prediction to predict the individual water and oil flow rates.

Optionally, the recovered differential pressure is used with a corresponding expansion flow rate prediction in conjunction with the component ratio of fluid components obtained from the sampled fluid, known individual component densities and a corresponding homogenous density prediction to predict the individual water and oil flow rates.

Optionally, the permanent pressure loss differential pressure is used with a corresponding PPL flow rate prediction in conjunction with the component ratio of fluid components obtained from the sampled fluid, known individual component densities and a corresponding homogenous density prediction to predict the individual water and oil flow rates.

Optionally, the method further comprises measuring a volume flow rate at a position downstream from where the differential pressure is measured and the fluid mixing occurs.

Optionally, the method comprises cross-referencing the total volume flow rate with a reading from the differential pressure meter to give an average mixture density, and combining said density with a component ratio obtained from the sampled fluid to determine the water flow rate and oil flow rates.

Optionally, the volume meter comprises one of: a vortex volume meter, an ultrasonic volume meter, a turbine volume meter, a positive displacement meter.

Optionally, sampling the fluid flow is performed downstream of the differential pressure measurement and upstream of the volume flow rate measurement.

Optionally, sampling the fluid flow is performed downstream from the volume flow rate measurement.

Optionally, the method comprises comparing the independent outputs of the DP meter/volume meter combination system, and the DP meter & separate sample with independently known component densities system, give redundancy and cross check diagnostic capability to the water with oil flow measurement system.

Optionally, the method comprises: calculating a flow rate prediction using a measured differential pressure; data fitting the calculated flow rate's over-reading to a set of known water to oil flow rate ratios or measures derived therefrom to produce a correction factor for the calculated flow rate prediction.

Optionally, the primary element is installed in horizontal pipe work.

Optionally, the primary element is installed in vertical pipe work.

Optionally, the primary element is installed in inclined pipe work.

Optionally, the fluid flow rate is a mass flow rate.

Optionally, the fluid flow rate is a volume flow rate.

According to a second aspect of the disclosure there is provided apparatus for metering fluid flow comprising at least two components comprising: a differential pressure flow meter comprising a primary element; and a sampler arranged to receive fluid flow after the components of the fluid flow are mixed by the primary element and to find a ratio of a first component of the fluid to a second component of the fluid from said sampled fluid.

Optionally, the apparatus comprises: a processor arranged to: for initially known individual component densities, calculate an average density from the ratio of a first component of the fluid to a second component of the fluid; calculate a total fluid flow rate based on a differential pressure measurement; and combine the total fluid flow rate and component ratios to determine a first fluid flow rate for the first component and a second fluid flow rate for the second component.

Optionally, the fluid flow is a single-phase flow. Alternatively, the fluid flow may be a multiphase flow.

Optionally, the primary element comprises a cone shaped structure within a fluid conduit.

Optionally, the primary element comprises a wedge shaped structure within a fluid conduit.

Optionally, the primary element comprises an orifice plate structure within a fluid conduit.

Optionally, the primary element comprises a Venturi-shaped constriction formed in a fluid conduit.

Optionally, the apparatus further comprises a volume flow meter at a position downstream from the differential pressure flow meter.

Optionally, the sampler is provided downstream of the differential pressure flow meter and upstream of the volume flow meter.

Optionally, the sampler is provided downstream of the volume flow meter.

Optionally, the primary element is installed in horizontal pipe work.

Optionally, the primary element is installed in vertical pipe work.

Optionally, the primary element is installed in inclined pipe work.

Optionally, the fluid flow rate is a mass flow rate.

Optionally, the fluid flow rate is a volume flow rate.

According to a third aspect of the disclosure there is provided a flow meter comprising an integrated primary element and fluid mixer.

According to a fourth aspect of the disclosure there is provided a computer program product comprising instructions that, when run on a computer enable it to perform calculation and various processing steps associated with the first aspect and to act as the processor of the second aspect.

The computer program product may be stored on or transmitted as one or more instructions or code on a computer-readable medium. Computer-readable media includes both computer storage media and communication media including any medium that facilitates transfer of a computer program from one place to another. A storage media may be any available media that can be accessed by a computer. By way of example such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fibre optic cable, twisted pair, digital subscriber line (DSL), or wireless technologies such as infra-red, radio, and microwave, then the coaxial cable, fibre optic cable, twisted pair, DSL, or wireless technologies such as infra-red, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The instructions or code associated with a computer-readable medium of the computer program product may be executed by a computer, e.g., by one or more processors, such as one or more digital signal processors (DSPs), general purpose microprocessors, ASICs, FPGAs, or other equivalent integrated or discrete logic circuitry.

### DRAWINGS

The disclosure will be described below, by way of example only, with reference to the accompanying drawings, in which:

FIG. 1 shows a sectioned illustrative view of a Cone Meter (flow is left to right).

FIG. 2 shows a 0.6 m/s, water and oil Flow (0.8 water cut) through 4″ (10.16 cm) diameter pipe work with Horizontal and Vertical Up Flow.

FIG. 3 shows a Ross Mixer.

FIG. 4 shows a Komax Mixer.

FIG. 5 shows a water and oil flow of 0.6 m/s and with ωₘ 0.5 mixed by a cone meter.

FIG. 6 shows a water and oil flow of 1.6 m/s and with ωₘ 0.2 mixed by a cone meter.

FIG. 7 shows a water and oil flow of 1.2 m/s and with ωₘ 0.5 mixed by a cone meter.

FIG. 8 shows a water and oil flow of 1.6 m/s and with ωₘ 0.5 mixed by a cone meter.

FIG. 9 shows a water and oil flow of 1.6 m/s and with ωₘ 0.75 mixed by a cone meter.

FIG. 10 shows a example metering set up showing a sampler downstream of a differential pressure meter.

FIG. 11 shows a cone meter with instrumentation sketch and pressure fluctuation graph.

FIG. 12 shows a Normalized diagnostic box (NDB) with diagnostic results, DP check included.

FIG. 13 shows a 6-inch (15.24 cm), 0.483β Cone Meter's Three Flow Coefficients in Homogenous Liquid Flow.

FIG. 14 shows a 6-inch (15.24 cm), 0.483β Cone Meter's Three DP Ratios in Homogenous Liquid Flow.

FIG. 15 shows a 6-inch (15.24 cm), 0.483β Cone Meter Water in Oil Results.

FIG. 16 shows a 6-inch (15.24 cm), 0.483β Cone Meter Water in Oil Uncorrected & Homogenous Model Corrected Results.

FIG. 17 shows a 6-inch (15.24 cm), 0.483β Cone Meter Water in Oil Homogenous Model Corrected Results.

FIG. 18 shows a 6-inch (15.24 cm), 0.483β Cone Meter Water in Oil Linear Fit Corrected Results.

FIG. 19 shows Random Examples of Baseline Diagnostic Results.

FIG. 20 shows Diagnostic Results from Random Oil Flow Example for Incorrect Inlet Diameter.

FIG. 21 shows Diagnostic Results from a Random Water Flow, with the example scenario of an Incorrect Cone Diameter.

FIG. 22 shows diagnostic results from Random Water in Oil Flows when the Meter is Serviceable.

FIG. 23 shows Diagnostic Results from Random Water in Oil Flow Points when the Discharge Coefficient is Correct and Incorrect.

FIG. 24 shows Diagnostic Results from Random Water in Oil Flow Points when the Traditional DP reading is Correct and when it is Saturated/Artificially Low.

FIG. 25 shows Diagnostic Results from Random Water in Oil Flow Points when the Traditional DP reading is Correct and when it is Artificially High.

FIG. 26 shows apparatus comprising a Cone Meter, Upstream of a Sample System, Upstream of a Vortex Volume Meter.

FIG. 27 shows apparatus comprising a Cone Meter, Upstream of a Sample System, Upstream of an Ultrasonic Volume Meter.

FIG. 28 shows apparatus comprising a Cone Meter, Upstream of a Sample System, Upstream of a Turbine Volume Meter.

### DESCRIPTION

Apart from a volume flow meter, another type of flow meter is the Differential Pressure (DP) meter. A DP meter comprises an obstruction to fluid flow and apparatus for measuring the pressure change caused by the obstruction, giving associated flow rate equations for either volume flow rate or mass flow rate, which are both functions of the fluid density. The obstruction is characterised by a “primary element” which can either be a constriction formed in the conduit or a structure inserted into the conduit. The primary element can be for example a constriction which may have a Venturi or other suitable profile, an orifice plate, a cone shaped element, a wedge shaped element, a four holed conditioning orifice plate element, an eccentric orifice plate element, a segmental orifice plate shaped element, a nozzle shaped element, or other suitable form.

The DP meter requires that a fluid density is supplied to the flow calculation from an independent fluid density measurement for either the volume or mass flow rate to be predicted (i.e. see equations 5 & 6). DP meters are not thought of by persons skilled in the art of flow metering as meters that would be deliberately applied to oil with water flow metering. However, the inventors have realised that because both volume and DP meters equally require the fluid density to be supplied by an external source in order to predict the mass flow there is therefore little practical difference between these meter type requirements.

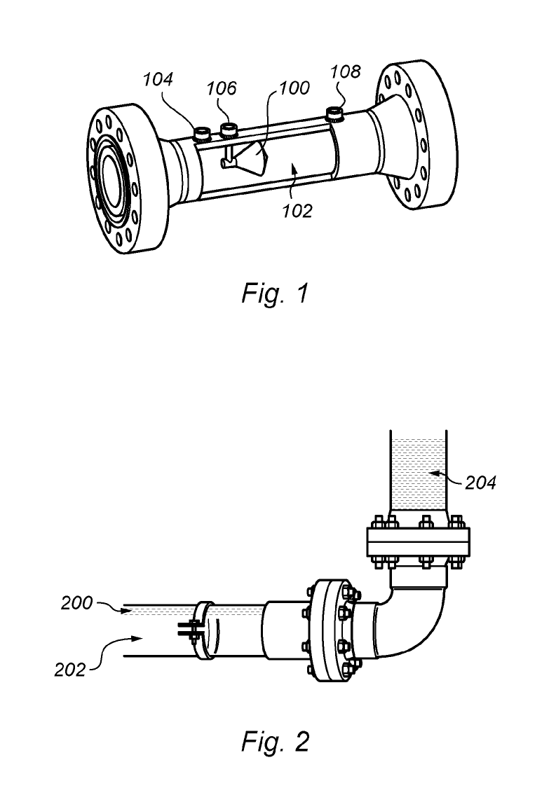

FIG. 1 shows an example of a typical DP meter, the cone meter. Here, a cone shaped primary element 100 is provided in a fluid conduit 102. Fluid flows from left to right as shown in the figure. The meter is provided with an upstream pressure port 104, downstream pressure port 108 and an intermediate pressure port 106 which is usually positioned at a point where pressure is minimised; or close to it. The pressure difference between the upstream and intermediate pressure ports gives a “traditional” DP, the pressure between the intermediate and downstream pressure ports gives a “recovered” DP, and the pressure between the upstream and downstream pressure ports gives a “permanent pressure loss”, or “PPL” DP.

Cone meters, like all DP meter designs, are not traditionally utilised for water in oil flow metering. All DP meters operate by using the principles of conservation of mass and energy applied via single-phase mass or volume flow DP meter equations, shown as equation 5 & 6.

$$\begin{matrix} m = {EA}_{t} {C}_{d} \sqrt{2 ρ Δ {P}_{t}} = {EA}_{t} {K}_{r} \sqrt{2 ρ Δ {P}_{r}} = {AK}_{ppl} \sqrt{2 ρ Δ {P}_{PPL}} & ( 5 ) \\ Q = \frac{m}{ρ} = {EA}_{t} {C}_{d} \sqrt{\frac{2 Δ {P}_{t}}{ρ}} = {EA}_{t} {K}_{r} \sqrt{\frac{2 Δ {P}_{r}}{ρ}} = {AK}_{PPL} \sqrt{\frac{2 Δ {P}_{PPL}}{ρ}} & ( 6 )\end{matrix}$$

Note:

m is the mass flow rate

Q is the volume flow rate

E is the “velocity of approach” (a geometric constant)

At is the minimum cross sectional (or “throat”) area

Cd, Kr & KPPL are the discharge, expansion & PPL coefficients respectively

ρ is the fluid density

ΔPt, ΔPr & ΔPPPL are the traditional, recovered & PPL differential pressures respectively.

Like volume meters, DP meters such as cone meters are designed to meter single-phase flows with one homogenous density. Neither volume nor DP meters are designed to cope with two fluids of different densities being present in a flow. Nevertheless, volume meters are traditionally applied to such flows with variable and debatable uncertainties in their volume flow rate output. Whereas, volume meters can produce an oil and water mixture volume flow rate prediction (of debatable uncertainty) without knowing the water cut (ω), and therefore not knowing the average fluid density, they still require the water cut/average fluid density from an external source in order to predict the water, oil and total mass flow rates. A DP meter also requires that the average fluid density be known from an external source in order to predict the water, oil and total mass flow rates mass or volume flow rates.

With the common but unproven industry starting assumption that a water with oil flow can be considered a pseudo-single-phase flow for the purpose of metering (if not sampling) we can combine equations 1 and 6 to get equation 6a. The sample system supplies the water cut (ω) and the water to oil mass flow rate ratio (ωm), see equation 15. As the oil and water individual densities are known equation 17 (see below) produces the homogenous density (ρh). Therefore, equation 16a (see below) produces the total volume flow rate and equation 6b (see below) produces the total mass flow rate. Combining this information with the sample supplied water to oil mass flow rate ratio (ωm) produces the water and oil volume flow rates, i.e. see equations 3 & 4. The water and oil mass flow rates are found by the product of these water and oil volume flow rates and the respective water and oil densities (known from an external source).

$$\begin{matrix}{Q}_{total} = {Q}_{oil} + {Q}_{water} = {EA}_{t} {C}_{d} \sqrt{\frac{2 Δ {P}_{t}}{{ρ}_{h}}} = {EA}_{t} {K}_{t} \sqrt{\frac{2 Δ {P}_{r}}{{ρ}_{h}}} = {AK}_{PPL} \sqrt{\frac{2 Δ {P}_{PPL}}{{ρ}_{h}}} & ( 6 a ) \\ {m}_{total} = {m}_{water} + {m}_{oil} = {ρ}_{h} * {Q}_{homogenous} & ( 6 b )\end{matrix}$$

If and when a sample gives an accurate water cut (ω) a representative density value must be produced from the oil and water densities and water cut. Industry uses an average value, i.e. the value if the two immiscible fluids were perfectly mixed. However, this is a contradiction in terms. The definition of ‘immiscible fluids’ is fluids that are “incapable of mixing or attaining homogeneity”, and here-in lies the industrial problem. Industry assumes the oil and water are mixed enough at the point of sampling that in practical terms the oil and water can be approximated as a homogenous mix. This inherent assumption must be correct if the oil and water flow rate predictions are to be correct. Hence, the traditional method of metering a water with oil flow relies on two distinct components: a mixer/sampler component and a flow meter component. The uncertainties of the oil and water flow rate predictions are dependent on both these components' output uncertainties.

Industry does have some guidelines regarding water in oil sampling, such as those seen in the API Manual of Petroleum Measurement Standards (MPMS) Chapter 8, Sampling, Section 2, Standard Practice for Automatic Sampling of Liquid Petroleum and Petroleum products, 2nd Ed, 1995. Sampling may be carried out after power mixing or static mixing, or by piping elements, in each case in horizontal or vertical orientations. However, industry guidelines give no preference to the type of mixer that should be used. In addition, industry guidelines teach that:

Power (or ‘active’) mixers, i.e. devices that do work on the oil with water mix, are assumed always to produce an adequate dispersion.

For no mixing elements at all, whether piping elements or a dedicated power or static mixer, the water in oil flow is assumed to be stratified or unpredictable.

Dedicated static (or ‘passive’) mixers, i.e. where the flow is made to do the work on the mixer instead of the power mixer doing work on the fluid, are considered better mixers than any piping elements.

Vertical flow produces adequate dispersion (i.e. sample quality mixing) at lower speeds than horizontal flow for any given piping element or static mixing device.

In order to guarantee adequate dispersion for a representative sample, it is necessary to supply some sort of mixing device upstream of the sampling location. The best mixing, i.e. the ‘active’ mixer which is a powered mixer that does work on the fluid, also requires the most logistics. It requires power and may have moving parts, making it relatively expensive to operate from the cost of the power supply and in carrying out regular maintenance. There may also be potential safety requirements, with a powered system requiring moving parts penetrating the hydrocarbon containment pipe.

The most common method of mixing is ‘passive’ mixing, i.e. a fixed mixing element where the fluid does the work on the element. This method is dependent on the fluid to supply the mixing energy. That is, the dynamic pressure drives the mixing. Whereas different designs of static mixer may be more effective than others for any given water with oil flow condition, i.e. given dynamic pressure, the effectiveness of any passive mixer design is dependent on the flow's dynamic pressure. For all passive mixer designs, as the total volume flow rate for a given water to oil flow rate ratio (i.e. dynamic pressure) increases so does the mixer device's effectiveness.

The level of mixing required to convert a water and oil flow to a near homogenous pseudo-single-phase mix is dependent on how mixed the flow is before the mixer. It is well understood that for any given water and oil flow condition the flow is naturally more mixed with vertical flow than horizontal flow. Horizontal flow has the gravitational/buoyancy effect acting perpendicular to the flow causing an active separation mechanism. Vertical flow has the gravitational/buoyancy effect acting along the pipe centre line thereby neutralizing this issue. This is illustrated in FIG. 2, which shows a still image of a 0.8 water cut oil and water fluid flowing at 0.6 m/s along a four inch (10.16 cm) fluid conduit in horizontal flow (from left to right) and then turning vertically upwards. The oil is dyed, and it can be seen in the horizontal section that oil 200 is well separated from water 202, but in the vertical portion the fluid 204 is mixed.

For any given water with oil flow condition vertical flows naturally have better mixing than horizontal flows. Therefore, for any given water with oil flow condition any given passive mixer design will have a better mixed flow at the inlet for vertical installations. Hence, for any given water with oil flow condition any given passive mixer design will have a better mixed flow at the outlet for vertical installations. However, most production pipe work is horizontal flow. Turning a pipe vertical up or down specifically to aid mixing is expensive (requiring U-bends and pipe supports) and significantly increases the system's ‘foot print’. Therefore, mixing is required for a water with oil flow sample, but a passive horizontal flow mixer is desirable, if the mixing achieved can be sufficient to produce a representative sample.

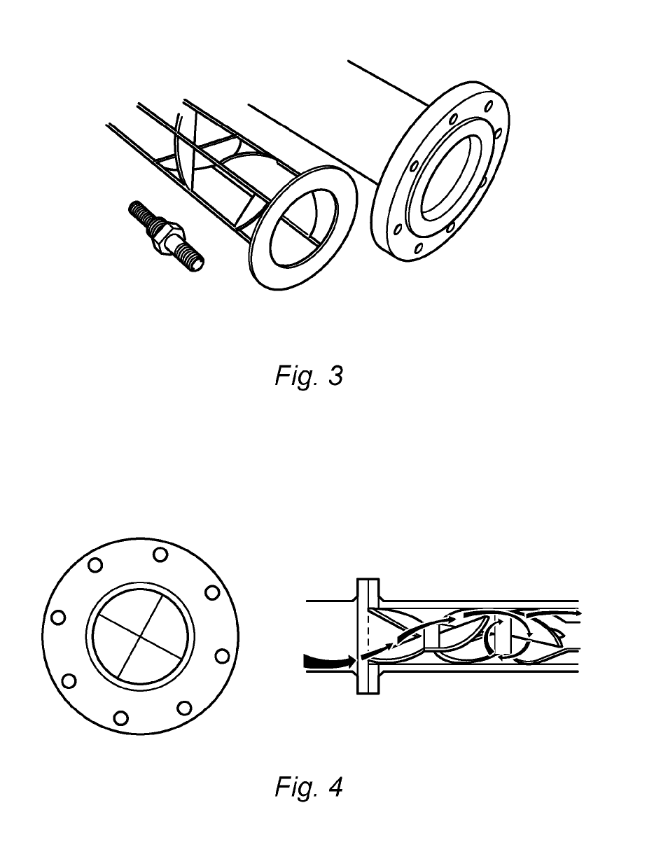

Two examples of common mixer designs are constructed by Komax Systems, Inc. (Komax) of California and Charles Ross & Son Company (Ross) of New York. Both mixers are nominally similar. The Ross mixer is shown in FIG. 3 and comprises a series of semi-elliptical plates positioned in series. Two plates perpendicular to each other make up a single ‘element’. Many Ross mixers use two elements. The distorted flow through these elements is said to create substantial mixing. A Ross mixer may be installed in horizontal or vertical pipe. The Komax mixer is shown in FIG. 4. It is similar to the Ross mixer and likewise may be installed in horizontal or vertical pipe. The Komax mixer has a different design of mixing plates to the Ross mixer, but again the distorted flow through these elements is said to create substantial mixing. An important feature of the Komax mixer is the addition of a last mixing element, i.e. a flat plate at the outlet of the mixer. The initial upstream mixing elements tend to induce upon the flow a significant swirl component (i.e. a rotation around the pipeline's axial centerline). This rotational component essentially aids separation (i.e. not mixing) through centrifugal forces throwing the water to the pipe wall. The flat plate located at the exit of the Komax mixer along the axis of flow diminishes swirl and therefore diminishes this separation mechanism.

Such mixers tend to be installed in vertical pipes rather than horizontal pipes as this aids mixing. Horizontal installations may require more elements than a vertical installation.

DP meters are used as single-phase flow meters for use with single component homogenous fluid properties.

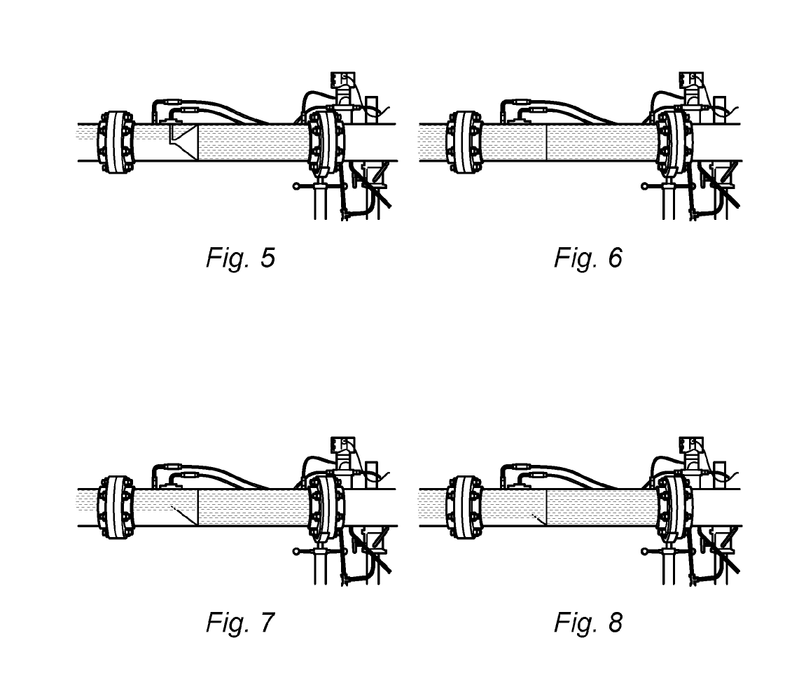

FIGS. 5 through 9 show a selection of horizontal cone meter flow tests carried out for liquid/liquid fluid mixes. These Figures show water (999 kg/m3) and oil (800 kg/m3) at atmospheric pressure flowing in a clear 6 inch (15.24 cm) pipe with a 6 inch (15.24 cm), 0.438 beta ratio (β) cone meter. Note the cone meter beta ratio is defined as:

$$β = \sqrt{\frac{{A}_{t}}{A} } = \sqrt{\frac{A - {A}_{c}}{A}} = \sqrt{1 - ( \frac{{A}_{c}}{A} )} = \sqrt{1 - {( \frac{{d}_{c}}{D} )}^{2}} \qquad ( 7 )$$

where A & D are the inlet cross sectional area and diameter respectively, A_{c} & dc are the cone element cross sectional area and diameter respectively, and Aₜ is the minimum cross sectional (or “throat”) area.

The beta ratio of a cone meter, i.e. the relative size of the cone to the pipe diameter, will have a significant effect on the mixing capability of the cone meter. The larger the cone relative to the meter body, i.e. the smaller the beta ratio, the higher the local flow velocity and dynamic pressure at the minimum cross sectional area and the better the mixing. That is, the larger the cone relative to the meter body the better a water with oil mixer the cone meter will be. However, the larger the cone relative to the meter body the greater the permanent pressure drop. Operators are sensitive to permanent pressure drop as this has to be countered by pumping costs. Hence, although a low cone meter beta ratio is beneficial to mixing it comes with an associated operational cost. A cone size can be chosen based on a suitable compromise for a given scenario.

The techniques discussed here use the cone meter as an example. However, the disclosure can apply to any type of DP meter, as all types will produce mixing, even if some are more effective than others. The amount of mixing will be dependent on the adverse pressure gradient and amount of flow separation after the DP meter throat (position of minimum pressure).

The 0.438 β tested here is a relatively large cone. Note in FIGS. 5 through 10 that the oil has been dyed red. FIGS. 5 through 10 are for horizontal flow tests. FIG. 5 shows a low speed of 2 ft/s (0.6 m/s) (left to right) and a high water to total mass flow (i.e. oil and water flow rate) ratio of 50%. At this low speed the upstream flow is clearly entirely separated, and not at all mixed. A significant amount of mixing is seen to have occurred across the large cone even for this low speed.

FIG. 6 shows a moderate speed of 5 ft/s (1.6 m/s) and a lower (but still substantial) water to total mass flow ratio of 20%. Whereas the flow visually looked well mixed by the turbulence in the upstream straight inlet pipe (with the cone meter being installed >70 pipe diameters (D) downstream of a 90 degree bend), there is a very distinct change in colour downstream of the cone indicting a significant increase in mixing. This pattern was consistent across all tests.

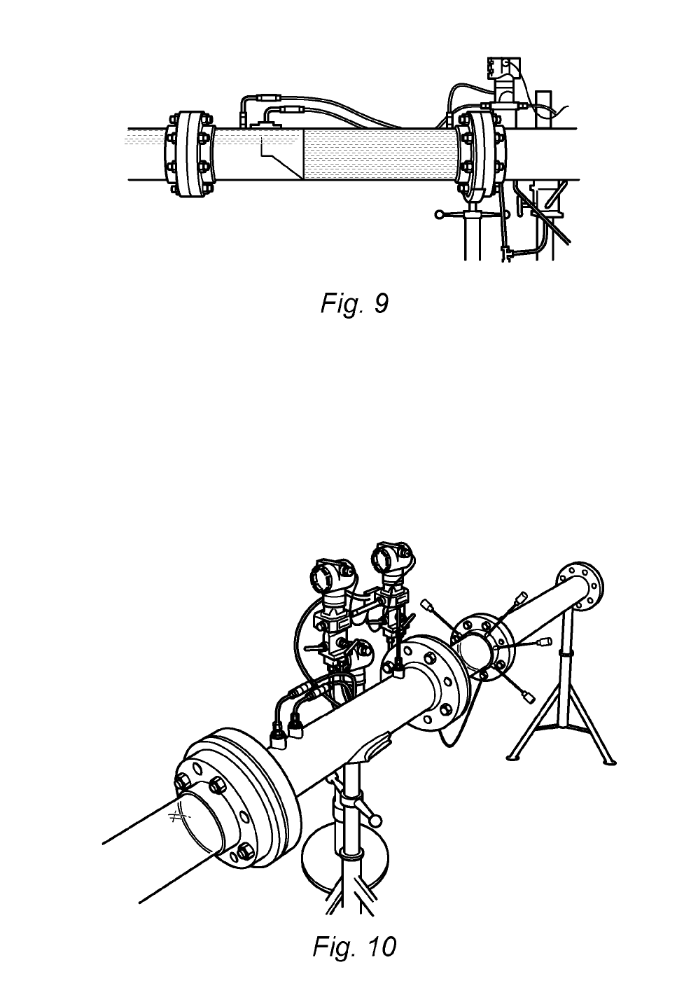

FIGS. 7 and 8 both show a high water to total mass flow ratio of 50%. FIG. 7 shows 4 ft/s (1.2 m/s) produced a moderately separated upstream flow and FIG. 8 shows 5 ft/s (1.6 m/s) produced a more mixed upstream flow. However, both flows were very significantly more mixed by the cone. Even at the very high water to total mass flow ratio of 75% at 5 ft/s (1.6 m/s) (see FIG. 9) where the inlet flow is clearly stratified, the flow exiting the cone element is clearly extremely mixed.

In all tests the mixing of the water in oil flows not only looked considerable but seemed to extend dozens of pipe diameters downstream before separation began to be evident.

Therefore it can be concluded that the cone element is a good water with oil flow mixer. Furthermore, it is simpler than the traditional mixer designs, and can also be used as the flow meter. That is, a DP meter could be used as a joint mixer and flow meter instead of the current practice of having a mixer component and a separate meter component.

Industry favours passive mixers. This is opposed to an active mixer doing work on the fluids, e.g. a recirculating jet system. All static mixer designs therefore depend on the flow's own energy (i.e. dynamic pressure) to mix the water and oil. Any static mixer design, for a given water to oil flow rate ratio and fluid properties, will be less efficient at lower flow rates. The lower the flow's dynamic pressure the less mixing any given static/passive mixer design can produce. This is a governing principle of all passive mixer designs.

All passive mixers benefit from and have better results in vertical flow compared to horizontal flow because any water in oil flow is more mixed in vertical flow at the inlet to the mixer. This is as true for DP meters as it is all other passive mixers.

However, DP meters (including as an example the cone meter) can be used in a horizontal installation. Just as other more conventional mixers (e.g. Ross and Komax mixers) can be used in horizontal installations as long as extra elements are applied to assure more mixing, a cone meter can be used in horizontal installations as long as the beta ratio is suitably low, i.e. the cone element is suitably large to assure more mixing. The horizontal cone meter installation tests shown in FIGS. 5 through 9 are for the case of a relatively small beta ratio (0.483β), i.e. a relatively large cone element. The smaller the cone meter's beta ratio, the larger the acceleration of the flow across the cone element, and the better the mixing.

Visual evidence of cone meter mixing is compelling (e.g. FIGS. 5 through 9) but not conclusive. Further evidence of the cone elements mixing capability can be obtained from separate technical considerations. Initial testing of a horizontally installed 6 inch (15.24 cm), 0.483β cone meter with an API compliant sample probe indicated that across a variety of water with oil flow conditions the samples water with oil flow rate ratio prediction matched the true value to low uncertainty. Initial testing of a horizontally installed 4 inch (10.16 cm), 0.630β cone meter with the same sample probe indicated that the water with oil flow rate ratio prediction uncertainty increased significantly at lower flow rates. This set-up is shown in FIG. 10, where the sample system can be clearly seen downstream of the DP meter.

Low flow rates (and low dynamic pressures) coupled with the moderate cone element size compromised the quality of the mixing. Hence, cone meters can be used as water with oil flow mixers in the horizontal location, but due to the physical law limitations that all passive mixer designs are bound by, there is a minimum flow velocity and beta ratio combination required (which is case dependent). The cone meter can most certainly be used without these constraints as a joint mixer and meter in vertical flow.

Water with oil flow is actually a single-phase flow of liquid with two components, water and oil—it is not a two-phase flow. On the other hand, wet gas flow where the flow is made up of a gas and a liquid phase is properly considered a two-phase flow.

However, when considering the flow of water with oil it is useful to use wet gas flow as an analogy. Each wet gas flow parameter can be converted for use with water with oil flows. In this analogy the oil flow of a water with oil flow is equivalent to the natural gas of a wet gas flow. The water flow of a water with oil flow is equivalent to the liquid flow of a wet gas flow. In such an analogy equivalent parameters to those used in wet gas flow technology can be used.

For water with oil flows, a modified Lockhart-Martinelli parameter (X*_{IM}) can be defined as:

$${X}_{LM}^{*} = \frac{{m}_{water}}{{m}_{oil}} \sqrt{\frac{{ρ}_{oil}}{{ρ}_{water}}} \qquad ( 8 )$$

where mₒᵢₗ an m_{water} are the oil and water mass flow rates and ρₒᵢₗ and ρ_{water} are the oil and water densities respectively. This can be compared to the wet gas flow Lockhart-Martinelli parameter defined as:

$${X}_{LM} = \frac{{m}_{l}}{{m}_{g}} \sqrt{\frac{{ρ}_{g}}{{ρ}_{l}}} \qquad ( 8 a )$$

where m_{g} and m_{g} are the gas and liquid mass flow rates and ρ_{g} and ρₗ are the gas and liquid densities respectively. For water with oil flows, a density ratio (DR*) is defined as:

$${DR}^{*} = \frac{{ρ}_{oil}}{{ρ}_{water}} \qquad ( 9 )$$

This can be compared to the wet gas flow density ratio (DR) defined as:

$$DR = \frac{{ρ}_{gas}}{{ρ}_{liquid}} \qquad ( 9 a )$$

For water with oil flows an oil densiometric Froude number (Frₒᵢₗ*) can be defined as the square root of the ratio of the oil inertia if it flowed alone to the gravitational force on the water phase. Here, g is the gravitational constant (9.81 m/s²).

$${Fr}_{oil}^{*} = \frac{{m}_{oil}}{A \sqrt{gD}} \sqrt{\frac{1}{{ρ}_{oil} ( {ρ}_{water} - {ρ}_{oil} )}} \qquad ( 10 )$$

This can be compared to the wet gas flow gas densiometric Froude number parameter (Fr_{g}) defined as:

$${Fr}_{g} = \frac{{m}_{g}}{A \sqrt{gD}} \sqrt{\frac{1}{{ρ}_{g} ( {ρ}_{;} - {ρ}_{g} )}} \qquad ( 10 a )$$

For water with oil flows a water densiometric Froude number (Fr_{w}*) can be defined as the square root of the ratio of the water inertia if it flowed alone to the gravitational force on the water phase. Here, g is the gravitational constant (9.81 m/s²).

$${Fr}_{w}^{*} = \frac{{m}_{water}}{A \sqrt{gD}} \sqrt{\frac{1}{{ρ}_{water} ( {ρ}_{water} - {ρ}_{oil} )}} \qquad ( 11 )$$

This can be compared to the wet gas flow liquid densiometric Froude number parameter (Frₗ) defined as:

$${Fr}_{l} = \frac{{m}_{l}}{A \sqrt{gD}} \sqrt{\frac{1}{{ρ}_{l} ( {ρ}_{;} - {ρ}_{g} )}} \qquad ( 11 a )$$

DP meters with wet gas flows tend to have a positive bias, or ‘over-reading’, on their gas flow rate prediction. The uncorrected gas mass flow rate prediction induced by a wet gas flow on a DP meter is often called the apparent gas mass flow, m_{g,apparent}. The wet gas flow over-reading is the ratio of the apparent to actual gas flow rate. DP meters with water in oil flows can also have the water induced oil flow rate prediction bias described as an ‘over-reading’. The uncorrected oil mass flow rate prediction can be called the apparent oil mass flow, m_{oil,apparent}.

m_{oil,apparent}=EAₜC_{d}\sqrt{2ρₒᵢₗΔPₜ} (12)

Hence, we have for ratio and percentage respectively:

$$\begin{matrix}{OR}_{oil} = \frac{{m}_{oil , apparent}}{{m}_{oil}} & ( 13 ) \\ {OR}_{oil} \% = ( \frac{{m}_{oil , apparent}}{{m}_{oil}} - 1 ) * 100 \% & ( 14 )\end{matrix}$$

This can be compared to the wet gas flow over-reading (OR) defined as:

$$\begin{matrix}OR = \frac{{m}_{g , apparent}}{{m}_{g}} & ( 13 a ) \\ OR \% = ( \frac{{m}_{g , apparent}}{{m}_{g}} - 1 ) * 100 \% & ( 14 a )\end{matrix}$$

The water-cut (ω) is defined as equation 2. Note that Q_{water} and Qₒᵢₗ are the water and oil actual volume flow rates.

$$ω = \frac{{Q}_{water}}{{Q}_{water} + {Q}_{oil}} = \frac{{Q}_{water}}{{Q}_{total}} \qquad ( 2 )$$

A water to oil mass flow rate ratio (ωₘ) can be utilised instead of the water cut (ω):

$${ω}_{m} = \frac{{m}_{water}}{{m}_{water} + {m}_{oil}} = \frac{{m}_{water}}{{m}_{total}} \qquad ( 15 )$$

The oil industry describes the amount of water with oil in terms of the water, i.e. ‘water cut’, denoted here by ‘ω’. The power/steam industries describes the amount of water with oil in terms of ‘quality’ (labelled the ‘dryness fraction’ in the US) which is denoted by a lower case ‘x’. Quality is defined by equation 16.

$$x = \frac{{m}_{g}}{{m}_{l} + {m}_{g}} = \frac{{m}_{g}}{{m}_{total}} \qquad ( 16 )$$

Therefore it can be said that:

$$1 - x = \frac{{m}_{l}}{{m}_{l} + {m}_{g}} = \frac{{m}_{l}}{{m}_{total}} \qquad ( 16 a )$$

Hence, the water with oil flows equation 15 is analogous with the wet gas flow equation 16a. A homogenous mix of water and oil flow has the homogenous density calculated by equation 17. This again, is analogous with the wet gas ‘homogenous’ density equation 17a.

$$\begin{matrix}{ρ}_{h} = \frac{{ρ}_{oil} \cdot {ρ}_{water}}{{ρ}_{water} ( 1 - {ω}_{m} ) + {ρ}_{oil} {ω}_{m}} & ( 17 ) \\ {ρ}_{h , wg} = \frac{{ρ}_{g} \cdot {ρ}_{l}}{{ρ}_{l} x + {ρ}_{g} ( 1 - x )} & ( 17 a )\end{matrix}$$

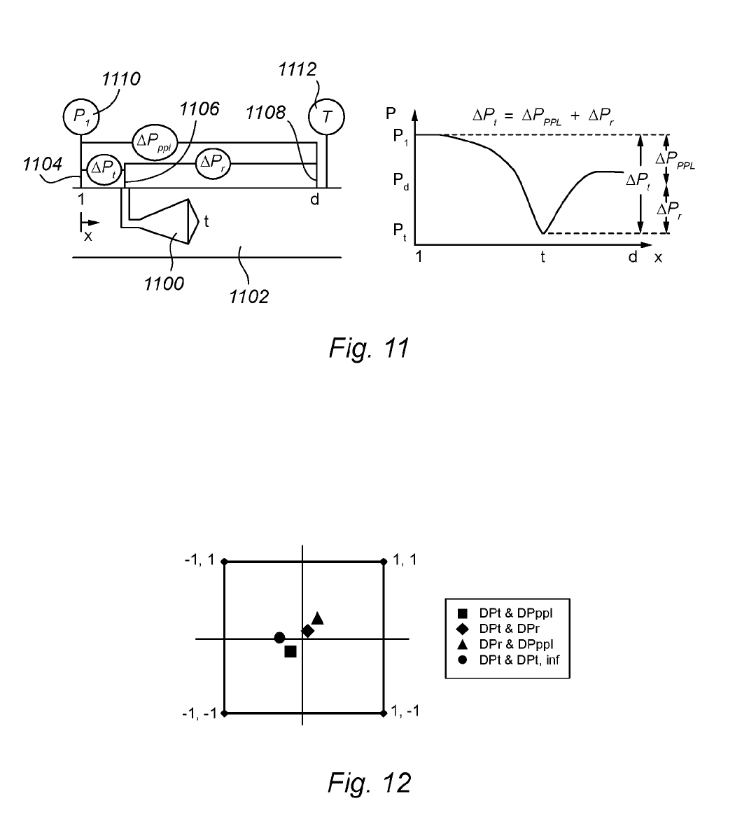

From this understanding of water in oil flow it is possible to apply diagnostic methods for DP meters. These diagnostic methods may comprise those set out in U.S. Pat. No. 8,136,414 and/or those in GB Patent No. 1309006.3. The contents of these disclosures are herein incorporated by reference. The following discussion on DP meter diagnostics holds for all DP meters. The cone meter is chosen here as an example, although any DP meter design could have been used. Generic DP meters (and hence cone meters) traditionally have two pressure ports and read a single DP measurement (i.e. the “traditional” DP, ΔPₜ). However, note that the cone meter shown in FIG. 1 and the clear body cone in FIGS. 5 through 9 have a third pressure tap downstream of the cone allowing two extra DPs to be read, i.e., the recovered DP (ΔPᵣ) and the permanent pressure loss (ΔPₚₚₗ). This is shown in the sketches of FIG. 11, which shows a cone meter and a pressure fluctuation graph. A cone-shaped primary element 1100 is provided in a fluid conduit 1102. Fluid flows from left to right, as indicated by the arrow. Three pressure taps are provided—an upstream tap 1104, intermediate tap 1106, and downstream tap 1108. The traditional, recovered and PPL differential pressures can be read as mentioned above. A pressure sensor 1110 is provided to give an upstream pressure reading, and a temperature sensor 1112 is provided for temperature monitoring and PVT calculation. The graph on the right hand side shows the pressure drop caused by the primary element, and shows the relationships between each of the DPs, i.e. that of equation 18 below.

The presence of the three pressure taps allows various DP meter diagnostic techniques to be applied to the cone meter. These techniques also apply to other DP meters.

The sum of the recovered DP and the PPL must equal the traditional differential pressure (equation 18). This fact allows a DP reading check.

ΔPₜ=ΔPᵣ+ΔP_{PPL} (18)

Traditional cone meter operation gives one flow rate equation (see equation 5a below, where function ‘ƒ’ represents the traditional flow rate equation). Each of the two new DPs have a corresponding flow rate equation, i.e. equation 19, where function ‘g’ represents the ‘expansion’ flow rate equation and equation 20, where function ‘h’ represents the ‘PPL’ flow rate equation.

Traditional Flow Equation:

mₜ=ƒ(ΔPₜ), i.e. m=EAₜC_{d}\sqrt{2ρΔPₜ} uncertainty ±x% (5a)

Expansion Flow Equation, i.e.:

m=EAₜKᵣ\sqrt{2ρΔPᵣ} uncertainty ±y% (19)

PPL Flow Equation:

m_{PPL}=h(ΔP_{PPL}), i.e. m=AKₚₚₗ\sqrt{2ρΔP_{PPL}} uncertainty ±z% (20)

Therefore, every DP meter body comprises in effect three flow meters. These three flow rate predictions can be compared. The percentage difference between any two flow rate predictions should not be greater than the root mean square of the two flow rate prediction uncertainties. If it is, then there is a meter malfunction. Table 2 shows the flow rate prediction pair diagnostics.

TABLE 2
Flow rate prediction pair diagnostics

| | % Actual | % Allowed | |
|---|---|---|---|
| Flow Prediction Pair | Difference | Difference | Diagnostic Check |
| Traditional & PPL | φ% | ψ% | −1 ≦ ψ%/φ% ≦ +1 |
| Traditional & | ξ% | λ% | −1 ≦ λ%/ξ% ≦ +1 |
| Expansion | | | |
| PPL & Expansion | υ% | χ% | −1 ≦ χ%/υ% ≦ +1 |

The three individual DPs can be used to independently predict the flow rates. With three flow rate predictions, there are three flow rate predictions pairs and therefore three flow rate diagnostic checks. In effect, the individual DPs are therefore being directly compared.

With three DPs read, there are three DP ratios:

PPL to Traditional DP ratio (PLR):

(ΔP_{PPL}/ΔPₜ)_{reference}, uncertainty ±a%

Recovered to Traditional DP ratio (PRR):

(ΔPᵣ/ΔPₜ)_{reference}, uncertainty ±b%

Recovered to PPL DP ratio (RPR):

(ΔPᵣ/ΔP_{PPL})_{reference}, uncertainty ±c%

Any cone meter's three DP ratios are characteristics of that meter. Actual DP ratios found in service can be compared to the expected values. The percentage difference between any DP ratio and its reference value should not be greater than the reference DP ratio uncertainty. Table 3 shows the flow rate prediction pair diagnostics.

TABLE 3
DP Ratio diagnostics

| DP | % Actual to | % Reference | |
|---|---|---|---|
| Ratio | Ref Difference | Uncertainty | Diagnostic Check |
| PLR | α% | a% | −1 ≦ α%/a% ≦ +1 |
| PRR | γ% | b% | −1 ≦ γ%/b% ≦ +1 |
| RPR | η% | c% | −1 ≦ η%/c% ≦ +1 |

Equation 18 holds true for all cone meters. Therefore, any inference that Equation 18 does not hold is a statement that there is a malfunction in one or more of the DP transmitters. The sum of the recovered and PPL DPs gives an ‘inferred’ traditional DP, ΔP_{t,inf}. The percentage difference between the inferred and directly read traditional DP should not be greater than the root mean square of the combined DP transmitter uncertainties. Table 4 shows the DP reading integrity diagnostics.

TABLE 4
DP Reading Integrity Diagnostic

| % Actual to Inferred | % RMS Combined DP | Diagnostic |
|---|---|---|
| Traditional DP Difference | Reading Uncertainty | Check |
| δ% | θ% | −1 ≦ δ%/θ% ≦ +1 |

Table 5 shows seven possible situations where these diagnostic would signal a warning. For convenience we use the following naming convention:

Normalized flow rate inter-comparisons:

x₁=ψ%/φ%, x₂=λ%/ξ%, x₃=χ%/υ%

Normalized DP ratio comparisons:

y₁=α%/a%, y₂=γ%/b%, y₃=η%/c%

Normalized DP sum comparison:

x₄=δ%/θ%

TABLE 5
The DP meter possible diagnostic results

| | | | | WARN- |
|---|---|---|---|---|
| DP Pair | No | WARNING | No | ING |
| ΔPₜ & ΔPₚₚₗ | −1 ≦ x₁ ≦ 1 | −1 < x₁ or x₁ > 1 | 1 ≦ y₁ ≦ 1 | −1 < y₁ or |
| ΔPₜ & ΔPᵣ | −1 ≦ x₂ ≦ 1 | −1 < x₂ or x₂ > 1 | 1 ≦ y₂ | −1 < y₂ or |
| ΔPᵣ & ΔPₚₚₗ | −1 ≦ x₃ ≦ 1 | −1 < x₃ or x₃ > 1 | 1 ≦ y₃ | −1 < y₃ or |
| ΔP_{t,read} & | −1 ≦ x₄ ≦ 1 | −1 < x₄ or x₄ > 1 | N/A | N/A |

For practical use, a graphical representation of the diagnostics is simple and effective. A box may be drawn centred on the origin of a graph. Four points are plotted on the graph representing the seven diagnostic checks, as shown in FIG. 12, where the x-axis represents a normalised flow rate comparison and DP check and the y-axis represents a normalised DP ratio comparison.

If the meter is serviceable all points fall inside the box. If there is a DP reading problem then the seventh diagnostic, i.e. the DP integrity check point, will be outside the box. If there is a meter body malfunction, one or more of the six meter body diagnostic checks cause one or more of the points to be outside the box.

If all four points are within the box the meter operator sees no metering problem and the flow rate prediction should be trusted. If one or more of the four points falls outside the box the meter is not operating correctly and that the flow rate prediction cannot be trusted. If there is a meter malfunction warning, the pattern of the points in such a plot gives significant information on the nature of the malfunction. Different malfunctions can cause different diagnostic patterns.

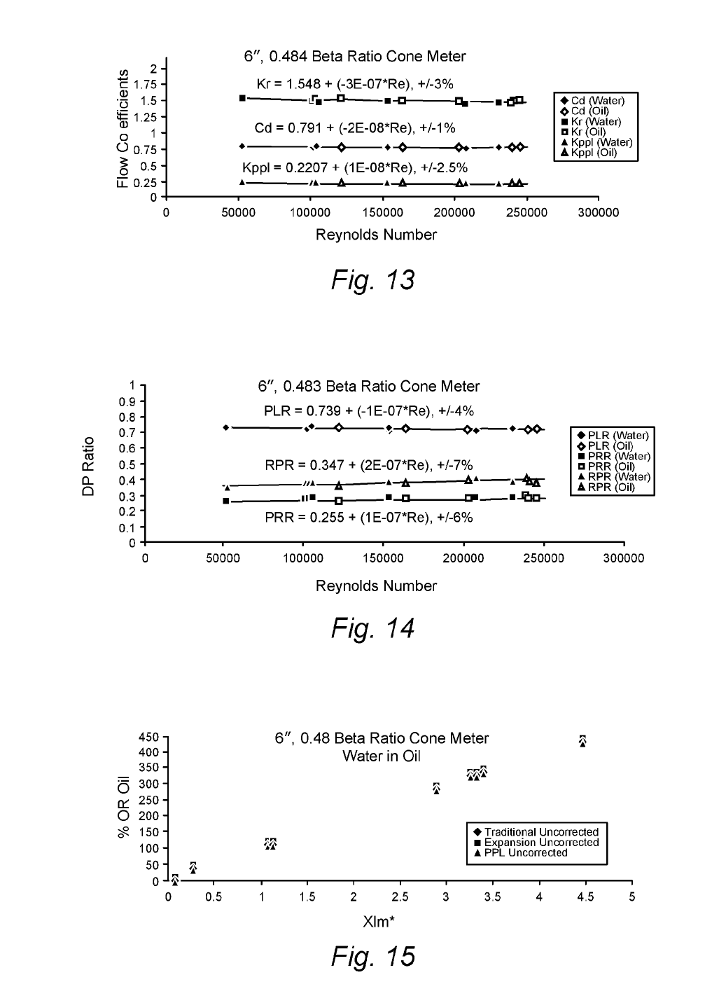

The cone meter (and all DP meters) with a downstream pressure tap has three flow rate calculations, equations 5a, 19 & 20. Each of the three flow equations has a flow coefficient, i.e. the traditional flow equation has the discharge coefficient (Cd), the expansion meter (measuring the recovered DP) has the expansion coefficient (Kr), and the PPL meter has the PPL coefficient (KPPL). Initial testing was conducted on oil flow only and then water flow only. These ‘baseline’ results for the flow coefficients and DP ratios are show in FIGS. 13 & 14.

FIG. 13 shows the cone meter had a 1% discharge coefficient uncertainty for either water or oil flow. The expansion coefficient and PPL coefficient were fitted to 3% and 2.5% respectively. Therefore, these check meters are not as accurate as the traditional method but still give important secondary flow rate information valuable for diagnostics. Likewise, the three DP ratios shown in FIG. 14 are shown to be unaffected by whether the flow is oil or water, and have been fitted to liner lines. The PLR fit had 4% uncertainty, the PRR fit had 6% uncertainty and the RPR fit has 7% uncertainty. These may look like large uncertainties but they are very useful in practical terms, as will be discussed below.

FIG. 15 shows the meter's three flow rate prediction methods responses to water in the oil flow in terms of the percentage oil flow rate over-reading (ORoil %) versus the modified Lockhart-Martinelli parameter (XLM*). All three flow rate predictions give approximately the same over-reading. It was noted that for this constant density ratio (DR*) of 0.82, the varying oil densiometric Froude number had no appreciable effect on the over-reading. It is known from wet gas flow research that this combination of the traditional, expansion & PPL flow rate predictions being approximately equal is a signature of fully homogenized flow. It is also independently known from wet gas flow research that the gas densiometric Froude number (which is the oil densiometric Froude number in this analogy) having no influence on the size of the over-reading is another signature of fully homogenized flow. Hence, the three flow rate predictions matching each other is a diagnostic check that the cone meter (or alternative DP meter) is mixing the water in oil flow to a near homogenous flow. This is in contrast to standard mixer technologies, which do not have any self-diagnostics to indicate they are working properly.

Again, an analogy with wet gas flow applies. The wet gas homogenous flow correction factor can be converted to produce a DP meter water in oil homogenous flow correction factor. The homogenous wet gas flow DP meter correction is equation set 21 & 22.

$$\begin{matrix}{m}_{g} = \frac{{m}_{g , apparent}}{OR} = \frac{{m}_{g , apparent}}{\sqrt{1 + {CX}_{LM} + {X}_{LM}^{2}}} & ( 21 ) \\ C = \sqrt{\frac{{ρ}_{g}}{{ρ}_{l}}} + \sqrt{\frac{{ρ}_{l}}{{ρ}_{g}}} & ( 22 )\end{matrix}$$

The equivalent homogenous water in oil DP meter correction is equation set 21a & 22a.

$$\begin{matrix}{m}_{oil} = \frac{{m}_{oil , apparent}}{{OR}_{oil}} = \frac{{m}_{oil , apparent}}{\sqrt{1 + {CX}_{LM}^{*} + {( {X}_{LM}^{*} )}^{2}}} & ( 21 a ) \\ C = \sqrt{\frac{{ρ}_{oil}}{{ρ}_{water}}} + \sqrt{\frac{{ρ}_{water}}{{ρ}_{oil}}} & ( 22 a )\end{matrix}$$

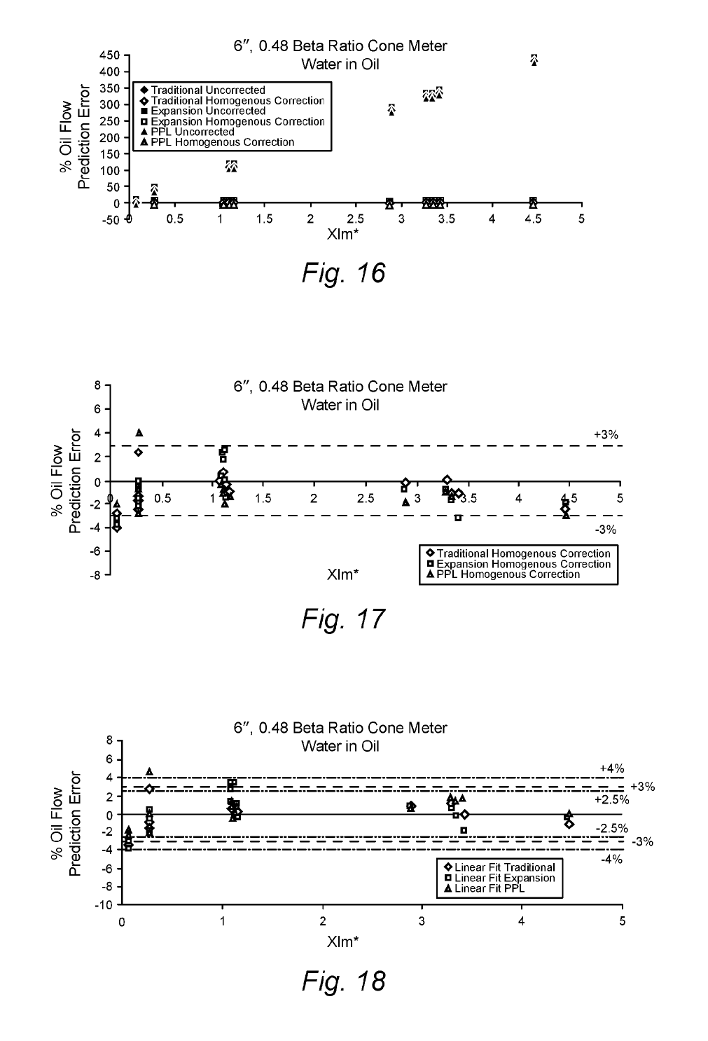

FIG. 16 shows the data of FIG. 15 with this homogenous water in oil DP meter correction included. It is assumed from the outset that the oil and water densities are known. To apply equation set 21a & 22a, equations 8 & 12 must be substituted into the equation set. Equation 8 requires the water to oil flow rate ratio be supplied from an external source. In FIG. 16 this external source comprises reference meters. In the field, the external source may be the sampling results. Clearly the homogenous correction method has a dramatic improvement of the oil flow prediction.

FIG. 17 shows only the homogenous model's correction results. The application of the homogenous model is a great improvement on no correction. The homogenous model corrects all three flow rate predictions from the cone meter to approximately 3% uncertainty. It is very noteworthy that the correction is NOT a data fit. This correction offering 3% uncertainty is a fully theoretical correction factor. This fact is the reason that there seems to be a slight negative bias in the results in FIG. 17 especially at higher modified Lockhart Martinelli parameter (X_{LM}*) values. If the cone meter was installed vertically upwards, the enhanced mixing would mean the meter performance would be closer still to homogenous flow. The homogenous correction model is applicable to all DP meter designs.

It is possible to data fit this horizontal cone meter data set to get a tighter fit. Linear data fits of the form shown as equation 23 were used here (although other more complicated forms of data fit can be chosen, the choice is arbitrary). This linear data fit choice is analogous to the wet gas DP meter ‘Murdock’ correlation, shown as equation 23a.

$$\begin{matrix}{m}_{oil} = \frac{{m}_{oil , apparent}}{{OR}_{oil}} = \frac{{m}_{oil , apparent}}{1 + {MX}_{LM}^{*}} & ( 23 ) \\ {m}_{g} = \frac{{m}_{g , apparent}}{OR} = \frac{{m}_{g , apparent}}{1 + {MX}_{LM}} & ( 23 a )\end{matrix}$$

The three gradients found in this example data set for the three linear fits of the three flow rate predictions were:

M_{traditional}=0.9857, Mₑₓₚₐₙₛᵢₒₙ=0.9825 & M_{PPL}=0.9650.

FIG. 18 shows the 6 inch (15.24 cm), 0.483β cone meter water with oil results when the oil flow rate over-reading is corrected for a known water to oil flow rate ratio with these linear fits. The traditional meter has the same corrected oil flow rate prediction uncertainty as the theoretical homogenous model. The expansion meter has a slightly higher corrected oil flow rate prediction uncertainty, with the exception of a single outlier, the PPL meter has a slightly reduced corrected oil flow rate prediction uncertainty. It is therefore possible for cone meters (or alternative DP meters) that the expansion or PPL meters may give as good an oil over-reading correction, or a better correction, than the traditional meter correction.

The diagnostics summarized above (as illustrated in FIGS. 11 and 12, and including the seven diagnostic parameters outlined above) work well with cone meters. These diagnostics are designed as homogenous flow DP meter diagnostics. These diagnostics used on cone meters can correctly indicate that a problem exists when the cone meter suffers many common problems, such as:

incorrect keypad entered inlet diameter

incorrect keypad entered cone diameter

DP transmitters problems (e.g. drift, over-ranging or incorrect calibration)

partial blockage at cone

deformation to the cone element

disturbed flow at cone meter

incorrect keypad entry of discharge coefficient

wet gas flow (in the common event the wet gas is not homogenously mixed)

This list is not exhaustive. Of the seven diagnostics set out in Table 5 above (x₁-x₃, y₁-y₃ & x₄) for standard single-phase homogenous flow, the only known DP/cone meter issue that is invisible to this diagnostics technique is an incorrect homogenous fluid properties (for example, density) entered into the flow computer/diagnostic software. The DP summation check does not use the density input. The DP ratio diagnostic techniques do not use the density input. The three flow rate equations which are inter-compared all use the same density input and therefore in this diagnostic check an incorrect density input is a common source problem and the density error cancels out in the cross check. The use of an incorrect density has no bearing on this DP meter diagnostic system. Whereas this is a minor limitation to the overall diagnostic system when applied in its normal single-phase homogenous flow applications, it is now useful that the diagnostics are insensitive to density issues in this water in oil application.

When an operator does not know the water cut of a water in oil production flow the overall metering system must determine it. The standard industry method is to mix the flow with some dedicated mixer device and take a sample downstream of this mixer. The sample give the flow's ‘water cut’. Traditionally the volume meter in the pipe line (not necessarily in the mixed flow region downstream of the mixer) is meant to correctly read the total volume flow. The individual oil and water flow rates are predicted by cross-referencing/combining the separate sample system water cut prediction and the volume meter's total volume flow rate prediction. The integrity of the water and oil flow rate predictions are therefore wholly dependent on the integrity of the sample system and the integrity of the volume meter. However, traditionally the volume meters (whether vortex meters, ultrasonic meters, turbine meters, positive displacement meters, etc.) do not have any comprehensive diagnostics when applied to water with oil flows. If these inherently single-phase homogenous fluid flow volume meter designs have any diagnostics, their diagnostic systems serviceability tend to be compromised by the fact that the fluid is actually water and oil flowing together.

It is proposed here that a DP meter may be used as both the mixer and the flow meter thereby eliminating the requirement for two separate pipe components of a mixer and a meter. Such a system can be installed in any pipe orientation. Such a system can be installed in vertical flow, as is common practice for standalone mixer designs with sample systems downstream.

However, it is also possible that such a system could be successfully installed in horizontal flow, given an appropriate flow velocity and beta ratio. Such an installation would alleviate the requirement for vertical up or down flow sections to aid mixing.

Furthermore, it is proposed that as the DP meter's diagnostics system is unaffected by density errors, the DP meter's single-phase homogenous fluid diagnostic system is entirely unaffected by the fact that the fluid is a mix of water and oil. This is different to the other meter designs which have their diagnostic systems significantly compromised by the fact that the fluid is a mix of water and oil. Hence, DP meters have better diagnostics in water with oil flows than other flow meters.

Also note that traditional mixer designs have no diagnostic system, i.e. no way of indicating the quality of the mixing. If a DP meter with a downstream pressure tap is used as a mixer, the DP meter's comparison of the three separate flow rate predictions offers a monitoring system to the quality of the mixing. The closer the three flow rate predictions match, the better mixed the water in oil flow is.

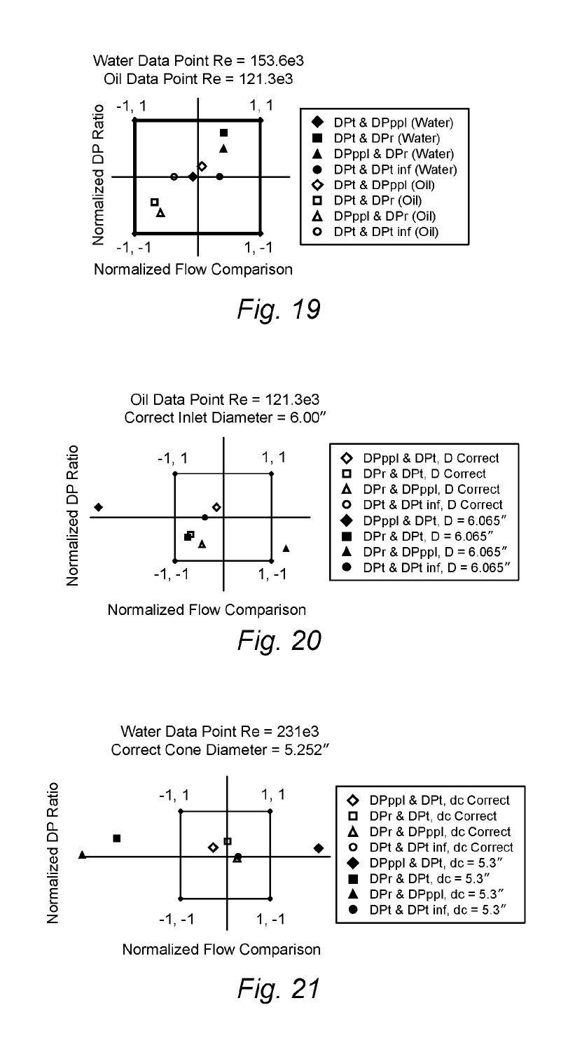

FIGS. 19 through 25 illustrate various examples of a cone meter single-phase flow diagnostic system being unaffected with water in oil flows. The 6 inch (15.24 cm), 0.483β clear body cone meter (shown in FIGS. 5 through 9) was fully calibrated (i.e. discharge coefficient and all diagnostic parameters) in water only flow and then oil only flow. The results are shown in FIGS. 13 & 14. Random samples of this correct baseline data diagnostic results plotted on a normalised diagnostic box (NDB) of the type shown in FIG. 12 are shown in FIG. 19.

First, let us consider random examples of the DP meter in use with water or oil flows when there is a meter problem. In the first example let us say there was an inlet diameter keypad entry bias. Say the inlet diameter 6.065 inches (15.405 cm) (i.e. 6 inch, schedule 40) was used instead of the correct value of 6.000 inches (15.24 cm). The traditional flow prediction has an error induced of +10%.

FIG. 20 shows the diagnostic result for correct and incorrect inlet geometries being used on a randomly chosen oil only flow. The diagnostics clearly identified when the problem exists.

Now let us say there was a cone diameter keypad entry bias. Say the cone diameter of 5.252 inches (13.340 cm) was used incorrectly entered as 5.3 inches (13.462 cm). The error induced on the randomly chosen water flow rate baseline point would have been −5.5%. FIG. 21 shows the diagnostic result for the correct and incorrect cone geometry being used. The diagnostics clearly identified when the problem exists.

The diagnostic system is shown to operate correctly with water or oil flows, as required.

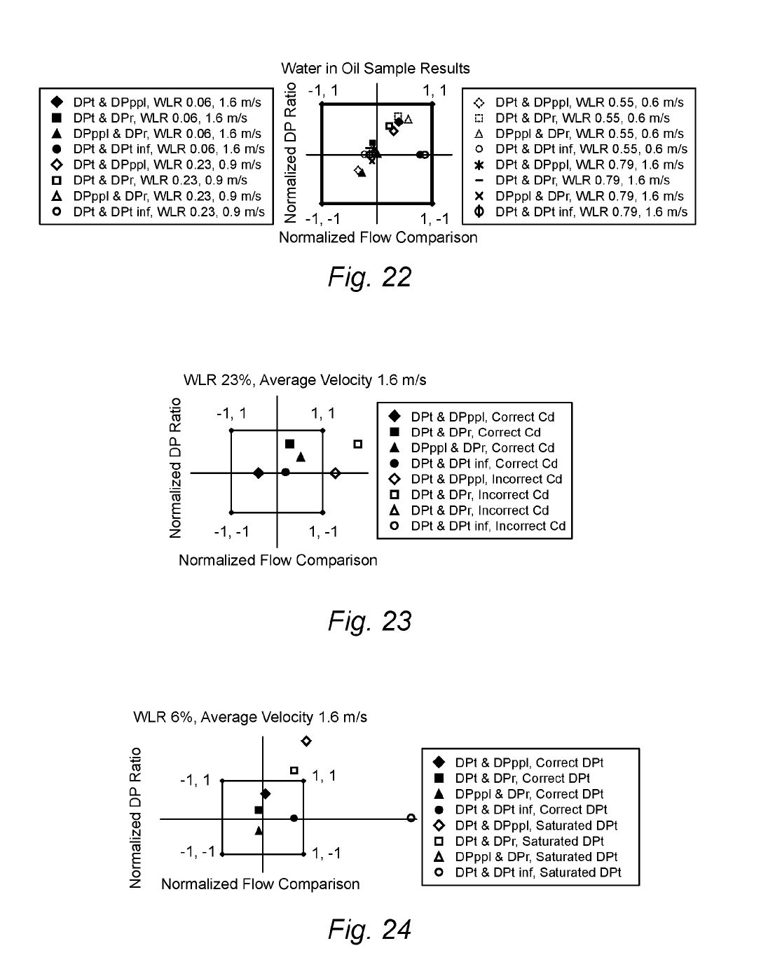

FIG. 22 shows sample data only (so as not to over-crowd the NDB), of various water with oil flow examples, when the cone meter is fully operational. Note that in FIG. 22 the term “WLR” means “ωm”. The fact that there are two fluids of different densities present, and the cone is mixing the two fluids, does not cause any adverse effects on the operation of the diagnostic system. By virtue of the diagnostics not being able to see density errors, the cone meter's diagnostic system is entirely immune, or ‘tolerant’, of the water in oil density ‘issue’. The diagnostics continue to monitor the rest of the meter's serviceability as normal.

Consider the effect if the cone meter has a malfunction when in water with oil flow metering service. Let us induce some problems on the meter. FIG. 23 compares the different diagnostics results for when a randomly chosen water with oil flow has a serviceable cone meter system and when the discharge coefficient (Cd) is incorrectly keypad entered. The true input should be Cd=0.791+(−2e−8*Re), but here the error of Cd=0.791+(−2e−7*Re) is simulated. The induced error was −4.6%. When the meter was serviceable no alarm is given. When the discharge coefficient was incorrect an alarm is raised.

FIG. 24 compares the different diagnostics results for when a randomly chosen water with oil flow has a serviceable cone meter and when the DP transmitter reading the traditional DP is saturated. The associated flow rate prediction error is −2.8%. When the meter was serviceable no alarm is given. When the DP transmitter gave the incorrect value an alarm was raised.

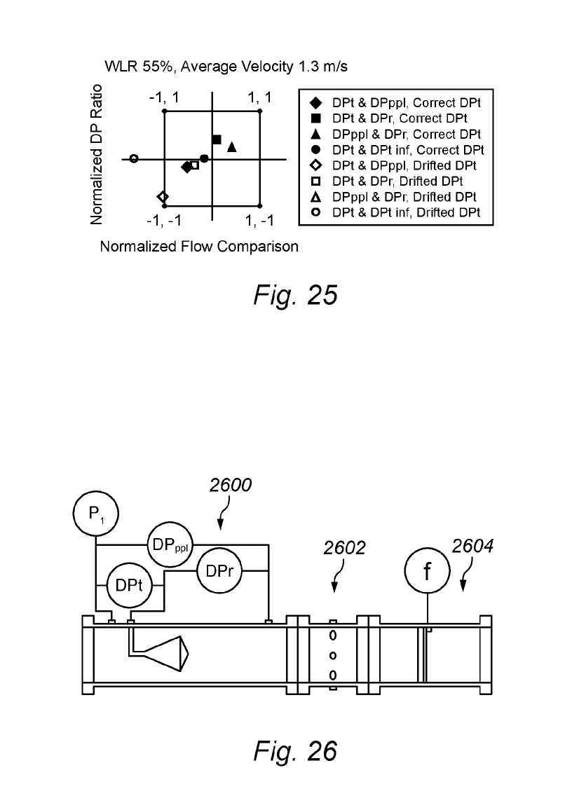

FIG. 25 compares the different diagnostics results for when a randomly chosen water with oil flow has a serviceable cone meter and when the DP transmitter reading the traditional DP has drifted to read an artificially high DP. The associated traditional flow rate prediction error is +1.5%. When the meter was serviceable no alarm was given. When the DP transmitter gave the incorrect value an alarm was raised.

The cone meter diagnostics are entirely intact for the case of water with oil flow applications. This gives cone meters an advantage over other flow meter designs when used in such an application. The same advantages may also apply to other forms of DP meter.

A combination of a volume meter and a DP meter may provide a mass flow meter. For a homogenous single-phase flow, a volume flow meter (such as a vortex meter, turbine meter, ultrasonic meter, positive displacement meters, etc.) produces a volume flow rate prediction (Q) independent of the fluid density (ρ). The mass flow rate (m) is then traditionally found by taking the product of that volume flow rate prediction and the density known from an external source (i.e. m=ρQ). DP meters (such as cone meters) require that a homogenous single-phase flow's density be known for either the volume or mass flow rate to be predicted.

If a volume meter and DP meter are in series their outputs can be cross-referenced to produce a mass flow rate, volume flow rate and density output with no prior knowledge of fluid density required. That is, equation 6 can be re-arranged to give equation 6c. If the volume meter supplies the volume flow rate (Q) the only unknown in the DP meter equation is the density that can then be found. Once the density is found the product of the volume meter's volume flow rate prediction and density gives the mass flow rate, or alternatively, this density prediction can be substituted into equation 5 to give the mass flow rate.

$$\begin{matrix}Q = \frac{m}{ρ} = {EA}_{t} {C}_{d} \sqrt{\frac{2 Δ {P}_{t}}{ρ}} & ( 6 ) \\ ρ = 2 Δ {{P}_{t} ( \frac{{EA}_{t} {C}_{d}}{Q} )}^{2} & ( 6 c )\end{matrix}$$

There are various different ways of constructing such a meter. A vortex meter's bluff body may be used as a DP meter's primary element to produce both a volume meter (i.e. the vortex meter) and DP meter (i.e. the DP across the bluff body of the vortex meter). Separate volume and DP meters could also be installed in series.

This present disclosure can apply to the case of two component (oil & water) one phase (liquid) flow, where the total mass flow is not known, and a DP meter, for example a cone meter is used in conjunction with a sample system to predict the water to oil flow rate ratio. That is, the cone element homogenizes the oil and water flow, and the corresponding sample gives the water to oil flow rate ratio. The homogenous (or other) correction factor then uses this water to oil flow rate ratio and cone meter output to predict the oil flow rate and water flow rate from the sample result.

Furthermore, the cone meter can have the full diagnostic suite available to monitor its correct operation. The cone meter can be installed in a horizontal or vertical orientation, although the horizontal orientation will need a lower beta ratio and a higher minimum total volume flow rate than the vertical orientation.

Due to the cone element being such a good mixer it may be useful to add a volume meter (e.g. an ultrasonic meter, turbine meter etc.) downstream of the cone element such that the oil/water homogenous mixture has its homogenous/total volume flow rate (Qhomogenous) predicted. Here then, the water with oil homogenous mix density equation 6d can be applied:

$${ρ}_{h} = 2 Δ {{P}_{t} ( \frac{{EA}_{t} {C}_{d}}{{Q}_{homogenous}} )}^{2} = 2 Δ {{P}_{r} ( \frac{{EA}_{t} {K}_{r}}{{Q}_{homogenous}} )}^{2} = 2 Δ {{P}_{PPL} ( \frac{{AK}_{PPL}}{{Q}_{homogenous}} )}^{2} \qquad ( 6 d )$$

This in turn allows equation 6b to give the total mass flow:

mₜₒₜₐₗ=m_{water}+mₒᵢₗ=ρₕ*Q_{homogenous} (6b)

With the oil and water densities known from an external source, the homogenous density found, the water to oil mass flow rate ratio (ωₘ) can be derived by re-arranging equation 17 to equation 17b. The water and oil mass flow rates can then be found from equations 15a & 15b respectively. The water and oil volume flow rates can be found from equations 24 & 25 respectively.

$$\begin{matrix}{ω}_{m} = \frac{{ρ}_{w} ( {ρ}_{h} - {ρ}_{oil} )}{{ρ}_{h} ( {ρ}_{water} - {ρ}_{oil} )} & ( 17 b ) \\ {m}_{water} = {ω}_{m} * {m}_{total} & ( 15 a ) \\ {m}_{oil} = ( 1 - {ω}_{m} ) * {m}_{total} & ( 15 b ) \\ {Q}_{water} = {m}_{water} / {ρ}_{water} & ( 24 ) \\ {Q}_{oil} = {m}_{oil} / {ρ}_{oil} & ( 25 )\end{matrix}$$

Again, the cone meter and volume meter combination can be installed in a horizontal or vertical orientation, although the horizontal orientation will need the cone meter to have a lower beta ratio and a higher minimum total volume flow rate than the vertical orientation to assure good mixing.

Regardless of the system orientation such a system is unlikely to be as accurate as a mixer/sample system when the flow has been successfully mixed. However, with high value oil production it is beneficial to have some redundancy in methods of predicting flow rates. Therefore, when the cone meter and sampling system combination is being used it is possible to add a volume meter downstream as a secondary system. This produces redundancy in the calculation systems and produces an oil and water flow rate prediction diagnostic capability by cross referencing this cone meter and volume meter combination systems output with the primary cone meter and sample system combined system output and the volume meter and sample system combined system output. Similar techniques can be applied for other DP meter designs.

Note that sampling is periodic and takes place in relatively short periods of time. It is a batch measurement method. With the sample port downstream of the cone meter, but upstream of the volume meter, the volume meter is effectively off line during the sampling process. The sample process means that there is less flow through the volume meter than through the cone meter and therefore the two meters cannot be compared during the sampling procedure. In practice the sample will be small compared to the total flow rates, but it is good practice to suspend volume meter readings during sampling.

One benefit of the installing a volume meter downstream of the cone meter is for continuous monitoring. Although the sampling technique is the primary technique, which is commonly considered the most accurate way of determining the water to oil flow rate ratio, it is a batch measurement technique. The metering system runs ‘blind’ to changes in water to oil flow rate ratio between sample times. That is, there is commonly in industry an unchecked assumption that the water to oil flow rate ratio has not changed between sampling times. Any such changes induce un-noticed metering biases. However, a volume meter and DP meter in combination will provide the average density. As we know the water and oil individual densities we know the water and oil split from the average density, hence from the volume meter's volume flow rate we know the oil and water flow rates continuously. Having the downstream volume meter present to combine with the DP meter in order to predict the water to oil flow rate ratio approximately, but continuously, is beneficial. It indicates when the water to oil flow rate ratio has changed and when a new sample needs to be taken. This allows condition based sampling as opposed to routine scheduled sampling, and reduces error due to water cut changes between sample times.

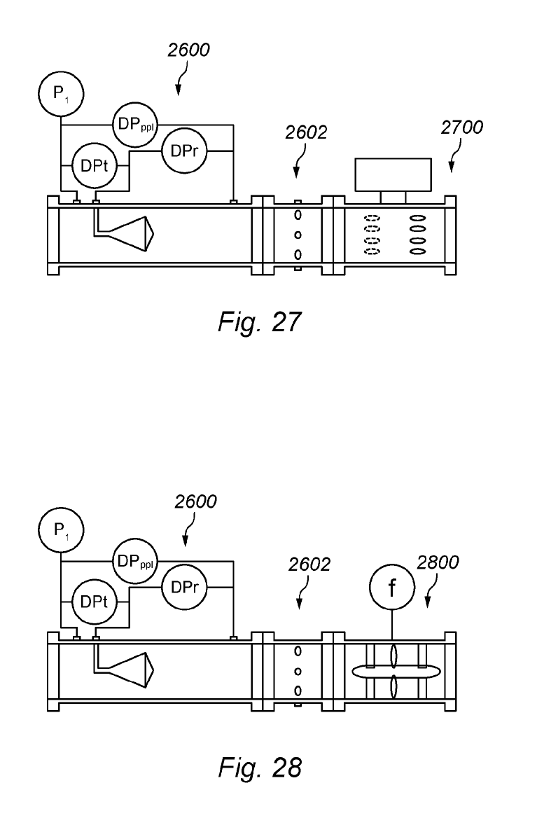

Various different volume meters may be used, some example of which are shown in FIGS. 26 through 28. A cone meter 2600 (as an example of any DP meter), of the type illustrated in FIG. 11, is provided upstream of a sampling system 2602. FIG. 26 shows a downstream vortex volume meter 2604, FIG. 27 shows a downstream ultrasonic volume meter 2700, and FIG. 28 shows a downstream turbine volume meter 2800.

The sampling system consists of one or more probes positioned radially around a spool piece where the probe tips are positioned in the flows cross section in an array dependent on the design being utilised. An example of a generic sample probe is given in API Manual of Petroleum Measurement Standards (MPMS) Chapter 8, Sampling, Section 2, Standard Practice for Automatic Sampling of Liquid Petroleum and Petroleum products, 2nd Ed, 1995. The technique disclosed here is not dependent on any one type of sample system.

A volume meter has a bluff body (to create the vortex shedding) and a sensor as shown in FIG. 26, 2604.

A Ultrasonic meter has a series of transducer ports that send ultrasonic frequency signals across the pipe to measure the flow as shown in FIG. 27, 2700.

A turbine meter has a central shaft and a series of blades that spin relative to the volume flow rate and a sensor, as shown in FIG. 28, 2800.

Various improvements and modifications can be made to the above without departing from the scope of the disclosure.

1-46. (canceled)

47. A method of metering a fluid flow having at least two components, the method comprising:
measuring a differential pressure caused by a primary element;
sampling the fluid flow after the components of the fluid flow are mixed by the primary element;
finding a ratio of a first component of the fluid to a second component of the fluid from said sampled fluid;
calculating, for initially known individual component densities, an average density from the ratio of a first component of the fluid to a second component of the fluid;
calculating a total fluid flow rate based on the differential pressure measurement; and
combining the total fluid flow rate and component ratios to determine a first fluid flow rate for the first component and a second fluid flow rate for the second component.

48. The method of claim 47, wherein the fluid flow is a single phase flow, or is a multiphase flow.

49. The method of claim 47, wherein the primary element comprises:
a cone shaped structure within a fluid conduit; or
a wedge shaped structure within a fluid conduit; or
an orifice plate structure within a fluid conduit; or
a Venturi-shaped constriction formed in a fluid conduit.

50. The method of claim 47, wherein the fluid flow comprises:
an oil component and a water component; or
an oil component and a water component with entrained gas.

51. The method of claim 47, wherein measuring a differential pressure comprises comparing the pressures between any two of:
a conduit position upstream of the primary element;
a conduit position downstream of the primary element; and
an intermediate conduit position between the upstream and downstream positions.

52. The method of claim 51, further comprising measuring at least two differential pressures selected from:
a permanent pressure loss (PPL) differential pressure taken between the upstream and downstream conduit positions;
a traditional differential pressure taken between the upstream and intermediate conduit positions;
a recovered differential pressure taken between the intermediate and downstream conduit positions.

53. The method of claim 52, further comprising:
calculating a fluid flow rate using one of the differential pressure measurements; and
monitoring the accuracy of this fluid flow rate by examining the relationship between the measured differential pressures.

54. The method of claim 52, further comprising:
calculating a fluid flow rate using each of the differential pressure measurements; and
determining that the fluid components are well mixed if the calculated flow rate predictions match each other.

55. The method of claim 51, wherein:
the traditional differential pressure is used with a corresponding traditional flow rate prediction in conjunction with the component ratio of fluid components obtained from the sampled fluid, known individual component densities and a corresponding homogenous density prediction to predict the individual water and oil flow rates; or
the recovered differential pressure is used with a corresponding expansion flow rate prediction in conjunction with the component ratio of fluid components obtained from the sampled fluid, known individual component densities and a corresponding homogenous density prediction to predict the individual water and oil flow rates; or
the permanent pressure loss differential pressure is used with a corresponding PPL flow rate prediction in conjunction with the component ratio of fluid components obtained from the sampled fluid, known individual component densities and a corresponding homogenous density prediction to predict the individual water and oil flow rates.

56. The method of claim 47, further comprising:
measuring a volume flow rate at a position downstream from where the differential pressure is measured and the fluid mixing occurs;
cross-referencing the total volume flow rate with a reading from the differential pressure meter to give an average mixture density; and
combining said density with a component ratio obtained from the sampled fluid to determine the water to oil flow rate split.

57. The method of claim 56, wherein sampling the fluid flow is performed downstream of the differential pressure measurement and upstream of the volume flow rate measurement.

58. The method of claim 56, wherein sampling the fluid flow is performed downstream from the volume flow rate measurement.

59. The method of claim 56, further comprising comparing the independent outputs of the DP meter/volume meter combination system, and the DP meter & separate sample with independently known component densities system, give redundancy and cross check diagnostic capability to the water with oil flow measurement system.

60. The method of claim 47, further comprising:
calculating a flow rate prediction using a measured differential pressure;
data fitting the calculated flow rate's over-reading to a set of known water to oil flow rate ratios or measures derived therefrom to produce a correction factor for the calculated flow rate prediction.

61. The method of claim 47, wherein the primary element is installed in:
horizontal pipe work; or
vertical pipe work; or
inclined pipe work.

62. An apparatus for metering fluid flow having at least two components, comprising:
a differential pressure flow meter having a primary element; and
a sampler arranged to receive fluid flow after the components of the fluid flow are mixed by the primary element and to find a ratio of a first component of the fluid to a second component of the fluid from said sampled fluid.

63. The apparatus of claim 62, further comprising:
a processor arranged to:
calculate, for initially known individual component densities, an average density from the ratio of a first component of the fluid to a second component of the fluid;
calculate a total fluid flow rate based on the differential pressure measurement; and
combine the total fluid flow rate and component ratios to determine a first fluid flow rate for the first component and a second fluid flow rate for the second component.

64. The apparatus of claim 62, wherein the primary element comprises:
a cone shaped structure within a fluid conduit; or
a wedge shaped structure within a fluid conduit; or
an orifice plate structure within a fluid conduit; or
a Venturi-shaped constriction formed in a fluid conduit.

65. The apparatus of claim 62, further comprising a volume flow meter at a position downstream from the differential pressure flow meter.

66. The apparatus of claim 65, wherein the sampler is provided downstream of the differential pressure flow meter and upstream of the volume flow meter.

67. The apparatus of claim 65, wherein the sampler is provided downstream of the volume flow meter.

68. The apparatus of claim 62, wherein the primary element is installed in:
horizontal pipe work; or
vertical pipe work; or
inclined pipe work.

69. A flow meter comprising:
an integrated primary element; and
a fluid mixer.

70. A computer program product comprising instructions that, when run on a computer enable it to perform calculation and various processing steps to implement a method of metering a fluid flow having at least two components, comprising:
measuring a differential pressure caused by a primary element;
sampling the fluid flow after the components of the fluid flow are mixed by the primary element;
finding a ratio of a first component of the fluid to a second component of the fluid from said sampled fluid;
calculating, for initially known individual component densities, an average density from the ratio of a first component of the fluid to a second component of the fluid;
calculating a total fluid flow rate based on the differential pressure measurement; and
combining the total fluid flow rate and component ratios to determine a first fluid flow rate for the first component and a second fluid flow rate for the second component.
